(19) United States
(12) Patent Application Publication
(10) Pub. No.: US 2026/0291078 A1
(43) Pub. Date: Sep. 24, 2026

(54) SCATTERING SURFACE DESIGN METHOD AND SCATTERING SURFACE DESIGN APPARATUS

(71) Applicant: ELECTRONICS AND TELECOMMUNICATIONS RESEARCH INSTITUTE, Daejeon (KR)

(72) Inventors: Sun Gyu LEE, Daejeon (KR); Jung Ick MOON, Daejeon (KR); Jung Nam LEE, Daejeon (KR)

(73) Assignee: ELECTRONICS AND TELECOMMUNICATIONS RESEARCH INSTITUTE, Daejeon (KR)

(21) Appl. No.: 19/573,560

(22) Filed: Mar. 20, 2026

(30) Foreign Application Priority Data
Mar. 20, 2025 (KR) 10-2025-0035809

(51) Int. Cl. H01Q 15/14; H01Q 3/44

(52) U.S. Cl. CPC H01Q 15/141; H01Q 3/44

(57) ABSTRACT

Provided is a scattering surface design method which designs a scattering surface on which super cells, each of which includes a plurality of unit cells, are regularly arranged. The scattering surface design method includes a step of setting a plurality of scattering surfaces defined with a parameter corresponding to beams formed by the super cells, a cost function evaluation step for the scattering surfaces, a genetic change step of changing the parameter using a genetic algorithm, a scattering characteristic evaluation step of computing a cost function from the parameter changed according to the genetic algorithm to evaluate a scattering characteristic, and a step of performing the genetic change step and the scattering characteristic evaluation step until an end condition for a targeting scattering characteristic is met.

### CROSS-REFERENCE TO RELATED APPLICATIONS

This application claims priority under 35 U.S.C. § 119 to Korean Patent Application No. 10-2025-0035809 filed on Mar. 20, 2025, in the Korean Intellectual Property Office, the disclosures of which are incorporated by reference herein in their entireties.

### BACKGROUND

Embodiments of the present disclosure described herein relate to a scattering surface design method and a scattering surface design apparatus.

As next-generation mobile communication, such as 5th generation (5G) and 6th generation (6G), has an advantage of using an upper-mid and millimeter wave (mmWave) frequency band which is a higher frequency band than previous 4th generation (4G) communication and transmitting more pieces of data at a Gbps-level speed in real time, it is applicable to virtual reality/augmented reality and industrial/infrastructure advancement to be in the spotlight in the industrial field as well as a private sector. In the band, propagation loss in air may increase as a wavelength becomes short, communication coverage may decrease due to a low diffraction characteristic, and a communication shadow area may occur as a radio wave does not arrive.

A high gain/high directivity beamforming scheme which uses more base stations and relay stations and uses a phased array antenna may be considered as a method for addressing such a problem. However, the high gain/high directivity beamforming scheme has difficulty in mass commercialization due to a complex phase-shifting circuit including a high-priced phase shifter and a power consumption problem for driving it and a complex operation scheme, such as multi-beamforming and multi-input and multi-output (MIMO) for providing a plurality of users with a communication service at the same time.

A reconfigurable intelligent surface (RIS) technology for solving disadvantages of the related art is presented, but a problem in which there is cost and power consumption still remains as a complex beamforming technology is used in terms of operation and a plurality of variable elements are used.

### SUMMARY

Using a radio wave scattering surface in a relay station is considered as a method for solving a next-generation communication coverage problem with low cost/no power using the present disclosure. The scattering surface should include a function for receiving a narrow beam of an incident wave of a base station or a relay station which is present in a far-field or radiative near-field and reradiating the beam in a specific angle range. In addition, the scattering surface can scatter radio waves at a wide angle with a similar level of power density because it receives more power with a larger effective aperture.

A metasurface or a frequency selective surface (FSS) may be considered as the scattering surface. It is possible to perform phase shift internally in unit cell level constituting the surface without a separate phase-shifting circuit to set a local phase of the scattering surface. Furthermore, these surfaces enable in-band full-duplex (IBFD) communication without any additional RF circuits and can operate in dual-polarization using only a symmetric unit cell structure. Therefore, the scattering surface technology has an advantage of low complexity/low cost/weight lightening/no power compared to a phased array antenna requiring active control and an RIS technology.

An existing scattering surface technology implements a surface for scattering a radio wave in a wide range using a 1-bit phase binary coding design, a repeated configuration of super units, and a corrugated surface to reduce a radar cross section (RCS). However, because there are plurality of nulls in a scattering pattern, when the surface is used for communication, a communication shadow area occurs near the null. Because the occurrence of the null is caused by offset interference between unit cell radiation elements, a probability of occurrence of the null more increases in a 1-bit low phase diversity condition. Although multiple bits are applied to increase phase diversity, there is a problem in which a desired scattering pattern is unable to be obtained due to irregular mutual coupling between adjacent unit cells. In another related art, a reflective array antenna for uniformly scattering a pencil beam without nulls in a specific range using an algorithm for forming and defocusing the pencil beam is developed. However, the reflective array antenna is implemented as only a reflective type and a first null beamwidth (FNBW) of a scattering pattern is about 40°. Because the reflective array antenna has a level similar to an antenna to which an existing flat-top technology is applied, it may be used to only expand limited communication coverage.

The present disclosure proposes an ultra-wide-angle electromagnetic scattering surface for expanding coverage of next-generation wireless communication. The present disclosure includes a scattering surface model for predicting a scattering pattern based on a local scattering coefficient of a scattering surface unit cell, a multi-beam synthesis-based flat-top pattern technology for expanding a beamwidth, a genetic algorithm (GA)-based optimization technology for generating a scattered wave without nulls in a set range angle, and a design and implementation technology using multi-bit coding. The present disclosure proposes various embodiments of scattering surfaces which apply the technologies to be implemented as a reflective type and a transmissive type on a printed circuit board (PCB).

According to an embodiment, a scattering surface design method for designing a scattering surface on which super cells, each of which includes a plurality of unit cells, are regularly arranged may include a step of setting a plurality of scattering surfaces defined with a parameter corresponding to beams formed by the super cells, a cost function evaluation step for the scattering surfaces, a genetic change step of changing the parameter using a genetic algorithm, a scattering characteristic evaluation step of computing a cost function from the parameter changed according to the genetic algorithm to evaluate a scattering characteristic, and a step of performing the genetic change step and the scattering characteristic evaluation step until an end condition for a targeting scattering characteristic is met.

According to any one aspect of the present embodiment, the parameter may include steering angles of the beam formed by the super cell and phase differences between the beams formed by the super cells. In such an aspect, the steering angle of the beam may correspond to a value for encoding a plurality of super cells.

According to any one aspect of the present embodiment, the set scattering surfaces may be defined with different parameters, respectively and may be set by a predetermined number, in the step of setting the scattering surfaces.

According to any one aspect of the present embodiment, the cost function evaluation step may be performed by computing a ripple in a main lobe of a radio wave scattered from the scattering surface defined with the parameter. In such an aspect, the cost function evaluation step may be performed by assigning smaller cost as the ripple in a main lobe of a beam scattered and formed by super cells included in the scattering surface is smaller in size and may be performed by selecting scattering surfaces of 10% to 50% having smallest cost among the plurality of set scattering surfaces.

According to any one aspect of the present embodiment, the genetic change step may be performed by including a step of performing mutation for changing any one or more of parameters corresponding to a beam defining the scattering surface in which a cost function is evaluated and a step of forming a scattering surface corresponding to new parameters formed as the mutation is performed.

According to any one aspect of the present embodiment, the genetic change step may be performed by including a step of performing cross-over for crossing over a portion of a sequence of parameters corresponding to a beam defining the scattering surface in which a cost function is evaluated and a step of forming a scattering surface including the super cells corresponding to a new parameter generated as the cross-over is performed.

According to any one aspect of the present embodiment, the cost function may be displayed with an equation cost function=max_{θ∈θ}_{_{S}}(|E^{S}(θ)|_{dB})−min_{θ∈θ}_{_{S}}(|E^{S}(θ)|_{dB})(E^{S}: an electromagnetic wave in a main lobe in a scattered wave and θ_{S}: a targeting optimization steering angle).

According to any one aspect of the present embodiment, the scattering surface may reflect or transmit an incident wave to form a scattered wave. The scattering surface for reflecting the incident wave may further include a ground. The scattering surface for transmitting the incident wave may be formed as one or more scattering surfaces are laminated.

According to an embodiment, a scattering surface design apparatus for designing a scattering surface including unit scattering cells arranged on a substrate may include a memory storing a design method program for designing a scattering surface and a processor that performs the design method program for designing the scattering surface. The processor may design a scattering surface on which super cells, each of which includes a plurality of unit cells, are regularly arranged. The processor may perform a step of setting a plurality of scattering surfaces defined with a parameter corresponding to beams formed by the super cells, a cost function evaluation step for the scattering surfaces, a genetic change step of changing the parameter using a genetic algorithm, a scattering characteristic evaluation step of computing a cost function from the parameter changed according to the genetic algorithm to evaluate a scattering characteristic, and a step of performing the genetic change step and the scattering characteristic evaluation step until an end condition for a targeting scattering characteristic is met.

According to any one aspect of the present embodiment, the parameter may include steering angles of the beam formed by the super cell and phase differences between the beams formed by the super cells. In such an aspect, the steering angle of the beam may correspond to a value for encoding a plurality of super cells.

According to any one aspect of the present embodiment, the set scattering surfaces may be defined with different parameters, respectively and may be set by a predetermined number, in the step of setting the scattering surfaces.

According to any one aspect of the present embodiment, the cost function evaluation step may be performed by computing a ripple in a main lobe of a radio wave scattered from the scattering surface defined with the parameter. In such an aspect, the cost function evaluation step may be performed by assigning smaller cost as the ripple in a main lobe of a beam scattered and formed by super cells included in the scattering surface is smaller in size and may be performed by selecting scattering surfaces of 10% to 50% having smallest cost among the plurality of set scattering surfaces.

According to any one aspect of the present embodiment, the genetic change step may be performed by including a step of performing mutation for changing any one or more of parameters corresponding to a beam defining the scattering surface in which a cost function is evaluated and a step of forming a scattering surface corresponding to new parameters formed as the mutation is performed.

According to any one aspect of the present embodiment, the genetic change step may be performed by including a step of performing cross-over for crossing over a portion of a sequence of parameters corresponding to a beam defining the scattering surface in which a cost function is evaluated and a step of forming a scattering surface including the super cells corresponding to a new parameter generated as the cross-over is performed.

According to any one aspect of the present embodiment, the cost function may be displayed with an equation cost function=max_{θ∈θ}_{_{S}}(|E^{S}(θ)|_{dB})−min_{θ∈θ}_{_{S}}(|E^{S}(θ)|_{dB}) (E^{S}: an electromagnetic wave in a main lobe in a scattered wave and θ_{S}: a targeting optimization steering angle).

According to any one aspect of the present embodiment, the scattering surface may reflect or transmit an incident wave to form a scattered wave. The scattering surface for reflecting the incident wave may further include a ground. The scattering surface for transmitting the incident wave may be formed as one or more scattering surfaces are laminated.

### BRIEF DESCRIPTION OF THE FIGURES

The above and other objects and features of the present disclosure will become apparent by describing in detail embodiments thereof with reference to the accompanying drawings.

FIG. 1A is a diagram illustrating the conventional beamforming repeater and FIG. 1B is a diagram illustrating the scattering surface method of the present disclosure.

FIG. 2 is a flowchart illustrating an overview of a scattering surface design method according to the present disclosure.

FIG. 3 is a block diagram schematically illustrating a design apparatus for designing a scattering surface including unit scattering cells arranged on a substrate.

FIG. 4 is a drawing schematically illustrating an upper surface of a scattering surface of the present embodiment.

FIGS. 5A, 5B, 5C, 5D, 5E, 5F, and 5G are drawings illustrating examples of states any one unit cell is able to have when coded with 2 bits.

FIG. 6A is a drawing illustrating beams to be obtained using a scattering surface of the present embodiment.

FIG. 6B is a drawing schematically illustrating a scattered wave formed with respective beams.

FIG. 7A is a drawing illustrating mutation for a beam steering angle sequence of selected scattering surfaces.

FIG. 7B is a drawing illustrating mutation for a phase angle sequence of selected scattering surfaces.

FIG. 8A is a drawing illustrating cross-over for a beam steering angle sequence of selected scattering surfaces and a beam steering angle sequence of scattering surfaces.

FIG. 8B is a drawing illustrating cross-over for a phase angle sequence of any one selected scattering surface and a phase angle sequence of another scattering surface.

FIGS. 9A, 9B, 9C, and 9D are drawings illustrating multi-bit coding phase distribution of a scattering surface designed under a condition, including 24×24 unit cells (size: 12 wavelengths×12 wavelengths), of 4-bit phase coding, a scattering range of [−40°, 40°], and various incident angles of {0°, 15°, 30°, 45°}.

FIGS. 10A, 10B, 10C, and 10D illustrate a reflective scattering surface structure in which an embodiment exemplified in FIGS. 9A, 9B, 9C, and 9D is implemented with a PCB.

FIGS. 11A, 11B, 11C, and 11D are drawings illustrating the result of simulating a scattering pattern of a TE wave which is a first polarized wave on the yz plane for reflective scattering surfaces of FIGS. 10A, 10B, 10C, and 10D.

FIGS. 12A, 12B, 12C, and 12D illustrate a scattering characteristic of a TM wave which is a second polarized wave.

FIG. 13 is a drawing illustrating a structure in which a design result under a condition of 24×24 elements (size: 12 wavelengths×12 wavelengths), 4-bit phase coding, a scattering surface of [−40°, 40°], and an incident angle of 0°, as an embodiment of a transmissive scattering surface, is implemented with a PCB.

FIG. 14 is a drawing illustrating the result of simulating a scattering pattern of a TE wave which is a first polarized wave on the yz plane for a transmissive scattering surface of FIG. 13.

FIG. 15 is a diagram illustrating the structure and phase change principle of a Cavity Phoenix Cell for reducing mutual coupling between adjacent cells while obtaining broadband characteristics, as another structure of the present embodiment.

FIG. 16 shows a reflective scattering surface implemented with the Cavity Phoenix Cell of FIG. 15.

FIG. 17A and FIG. 17B are diagrams showing the scattering pattern on the yz plane for the reflective scattering surface of FIG. 16, where FIG. 17A shows the results for the first polarization (TE wave) and FIG. 17B shows the results for the second polarization (TM wave).

FIG. 18A and FIG. 18B are diagrams comparing the frequency-dependent scattering patterns of a reflective scattering surface designed with a general patch unit cell (FIG. 18A) and a Cavity Phoenix Cell according to an embodiment of the present invention (FIG. 18B).

### DETAILED DESCRIPTION

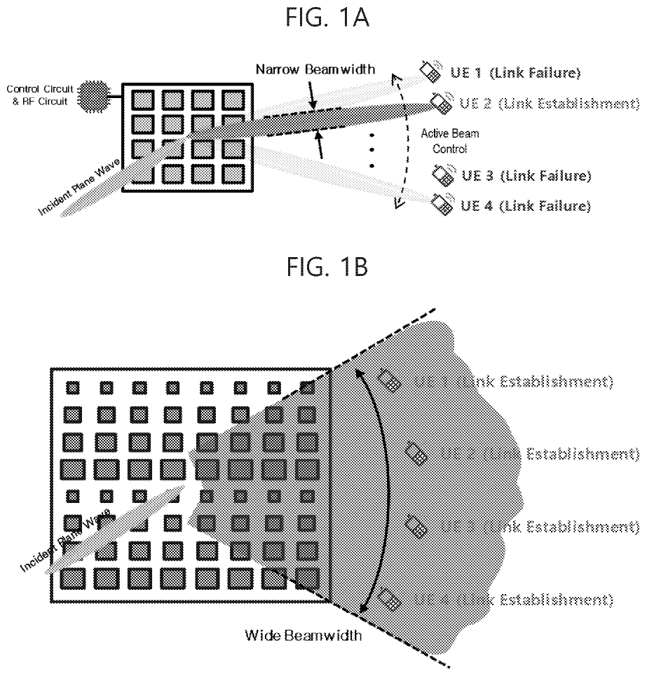

Hereinafter, the present embodiment will be described with reference to the accompanying drawings. However, in describing embodiments which will be described below, the term “scattering” may be interpreted as the meaning including both of “reflection” and “transmission”. Thus, the scattering surface according to the present disclosure may refer to reflecting and diffusing an incident radio wave. Furthermore, the scattering surface of the present disclosure may transmit and diffuse the incident radio wave. FIG. 1A is a diagram illustrating a conventional beamforming repeater, and FIG. 1B is a diagram illustrating the scattering surface method of the present invention. According to the conventional method, the RIS receives an external incident plane wave, re-radiates it, and transmits it to the User Equipment (UE). Since beamforming-based RISs have a narrow beam, they must perform communication by precisely searching for and tracking the location of the User Equipment. Consequently, control circuits and RF circuits are required to control the phase of the unit cell, which has the disadvantage of increasing costs and power consumption.

On the other hand, the method of the present disclosure receives the incident wave at a passive surface and scatters the radio waves over a wide range, so it does not require a separate search and tracking process and has the advantage of being able to provide simultaneous communication services to multiple User Equipment.

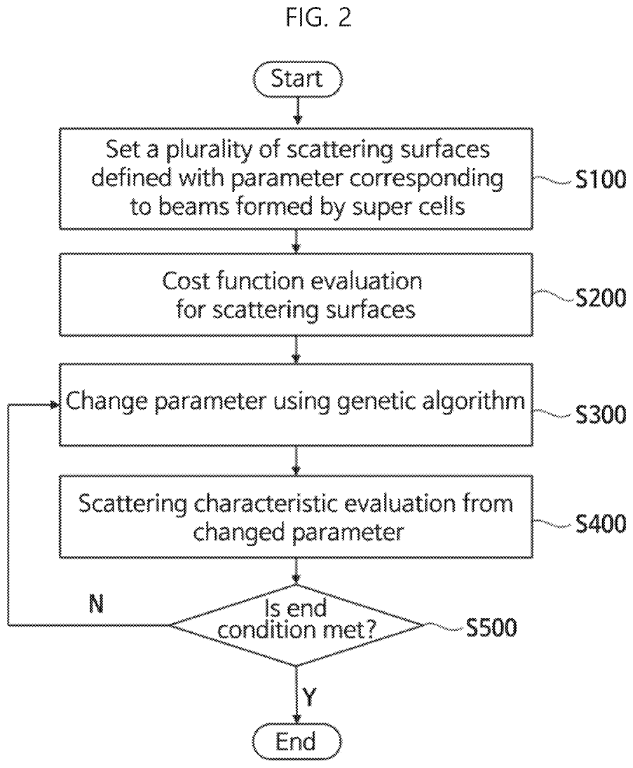

FIG. 2 is a flowchart illustrating an overview of a scattering surface design method according to the present disclosure. Referring to FIG. 2, the scattering surface design method of the present disclosure is a method for designing a scattering surface on which super cells, each of which includes a plurality of unit cells, are regularly arranged, which may include a step (S100) of setting a plurality of scattering surfaces defined with a parameter corresponding to beams formed by the super cells, a cost function evaluation step (S200) for the scattering surfaces, a genetic change step (S300) of changing the parameter using a genetic algorithm, a scattering characteristic evaluation step (S400) of computing a cost function from the parameter changed according to the genetic algorithm to evaluate a scattering characteristic, and a step (S500) of performing the genetic change step (S300) and the scattering characteristic evaluation step (S400) until an end condition for a targeting scattering characteristic is met.

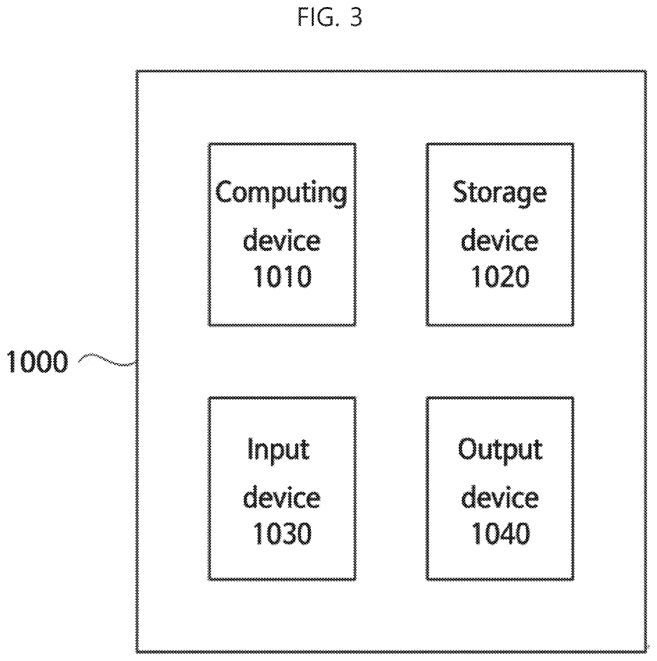

FIG. 3 is a block diagram schematically illustrating a design apparatus 1000 for designing a scattering surface including unit scattering cells arranged on a substrate. Software of a method for designing a scattering surface may be provided in a circuit and a chipset composed of a memory and a computing element. FIG. 3 is an example illustrating a configuration for the apparatus 1000 loaded with scattering surface design method software, without limiting a physical configuration. The design apparatus 1000 exemplified in FIG. 3 may be a PC, a server, a chip, or the like.

The apparatus 1000 loaded with the scattering surface design method software may include an input device 1030, a computing device 1010 including a processor for performing a scattering surface design method, and a storage device 1020 including a memory which stores the scattering surface design method software. The apparatus 1000 loaded with the scattering surface design method software may further include an output device 1040.

The input device 1030 may receive data necessary to run the scattering surface design method software. The input device 1030 may receive parameters including beam steering angles of scattering surfaces, a phase difference of a super cell, and the like. As an embodiment, the input device 1030 may be a communication device and an interface device, which receive measurement data from a network. Furthermore, the input device 1030 may also be an interface device for receiving measurement data over a wired network. Meanwhile, the input device 1030 may also receive an external control signal. As an example, the data necessary to run the scattering surface design method software may be input via the input device 1030 by a user.

The storage device 1020 may include the memory and may store a scattering surface design method software model. The storage device 1020 may be implemented with various media, such as a semiconductor storage device and a hard disk, which may store data. The storage device 1020 may store the scattering surface design method software and may store various pieces of information and various parameters used in a computing process, and may store the computed result.

The computing device 1010 may include the processor and may run the scattering surface design method software stored in the memory to perform the scattering surface design method software. Furthermore, the computing device 1010 may compute a frequency response of a scattering surface designed based on the computed result.

The computing device 1010 may correspond to a device which runs a certain command and program to process data. The computing device 1010 may be implemented with a cache memory for temporarily storing a command and information and a processor for performing computation. The processor may be implemented as a central processing unit (CPU), an application processor (AP), a field-programmable gate array (FPGA), or the like depending on a type of an apparatus.

The output device 1040 may be a communication device which transmits necessary data to the outside. The output device 1040 may transmit a result value derived by the scattering surface design method software to the outside. In some cases, the output device 1040 may be a device which outputs a scattering surface design method software learning process or a result value derived by the scattering surface design method software on a screen.

Furthermore, the above-mentioned scattering surface design method may be implemented with a program (or an application) including an executable algorithm capable of being executed by a computer. The program may be stored and provided in a non-transitory computer-readable medium.

The non-transitory readable medium refers to a medium capable of storing data semi-permanently and being read by a device, rather than a medium which stores data for a short time, such as a register, a cache, or a memory. In detail, the above-mentioned various applications or programs may be stored and provided in the non-transitory computer-readable medium, such as a compact disc (CD), a digital versatile disc (DVD), a hard disk, a blue-ray disc, a universal serial bus (USB), a memory card, or a read-only memory (ROM).

The processor included in the computing device 1010 of the scattering surface design apparatus exemplified in FIG. 3 may design a scattering surface on which super cells, each of which includes a plurality of unit cells, are regularly arranged. The processor may perform a step of setting a plurality of scattering surfaces defined with a parameter corresponding to beams formed by the super cells, a cost function evaluation step for the plurality of set scattering surfaces, a genetic change step of changing the parameter using a genetic algorithm, a scattering characteristic evaluation step of computing a cost function from the parameter changed according to the genetic algorithm to evaluate a scattering characteristic, and a step of performing the genetic change step and the scattering characteristic evaluation step until an end condition for a targeting scattering characteristic is met.

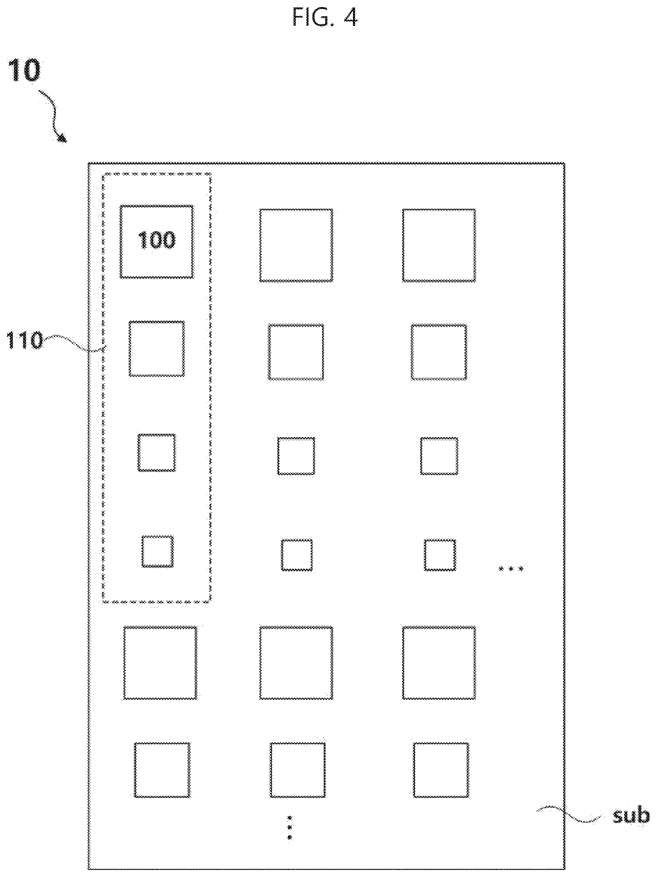

FIG. 4 is a drawing schematically illustrating an upper surface of a scattering surface 10 of the present embodiment. In an embodiment exemplified in FIG. 4, the scattering surface 10 may include unit scattering cells 100 arranged on a substrate sub. The substrate sub may be a dielectric substrate, which may be formed of a transparent material for a radio wave and may include a ground for reflecting a radio wave. Each of the unit cells 100 may include a metal film.

The unit cells 100 may be regularly arranged. A predetermined number of unit cells may be grouped to form a super cell 110. All the unit cells 100 of FIG. 4 are exemplified as having a quadrangular shape, but this is merely an example. As will be described below, the unit cells 100 may have different sizes, different shapes, different depths, different heights, or the like depending on a coded value.

The super cell 110 is exemplified as including the four unit cells 100 in the illustrated example, but this is merely example. The super cell 110 may include more than four unit cells or less than four unit cells.

The one super cell 110 may have a phase gradient for a beam steering angle. The plurality of unit cells 100 included in the super cell 110 may be coded with a phase value which gradually increases or decreases to meet the phase gradient. Thus, the super cell 110 including the unit cells 100 may form a wavefront which is a plane having the same phase to steer a beam in a specific direction. A steering angle of the beam formed by the super cell 110 may be set from it. However, values for coding the super cell 110 may change in steering angle by a genetic algorithm which will be described below.

As an embodiment, when any one scattering surface 10 includes 24×24 unit cells 100 and four unit cells 100 adjacent in a direction of any one of a row or a column form one super cell 110, the scattering surface 10 may include 6×24 super cells.

As another embodiment, when any one scattering surface includes 24×24 unit cells and one super cell includes two unit cells adjacent along a row direction and two unit cells adjacent along a column direction, the scattering surface may include 12×12 super cells.

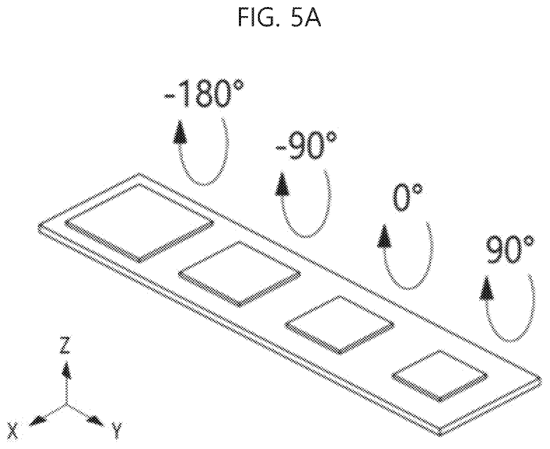

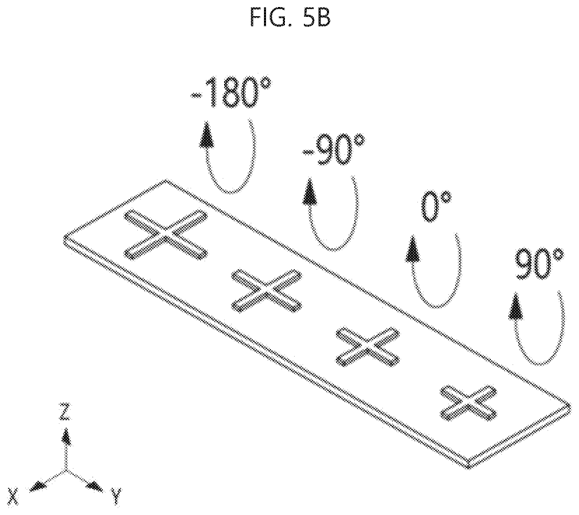

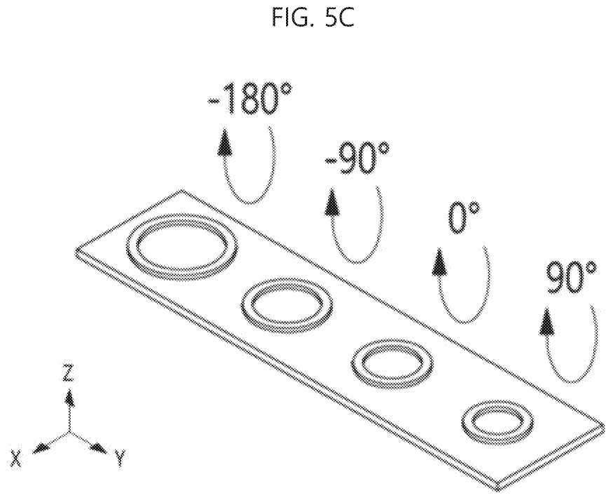

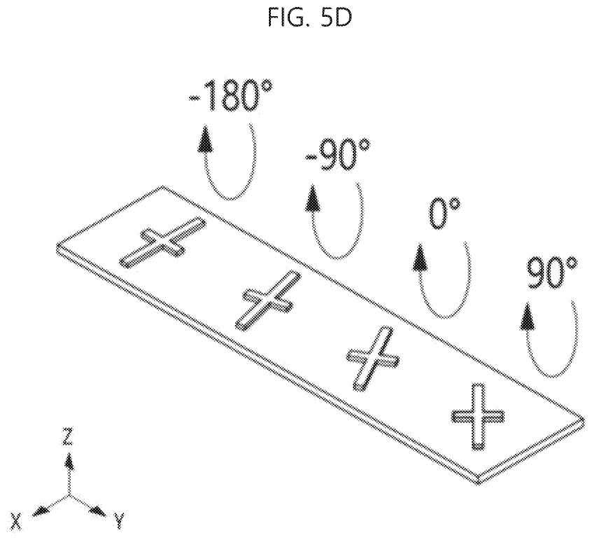

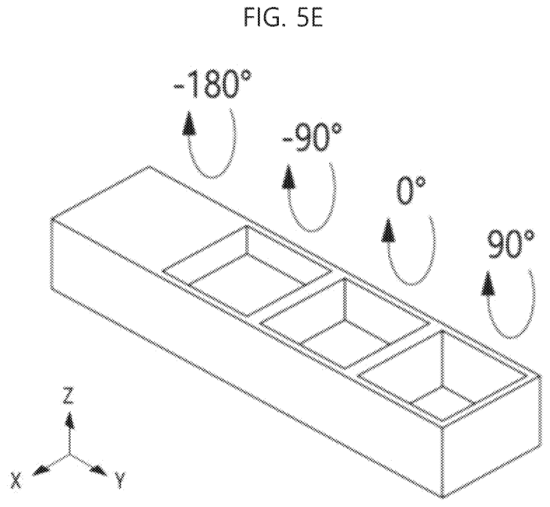

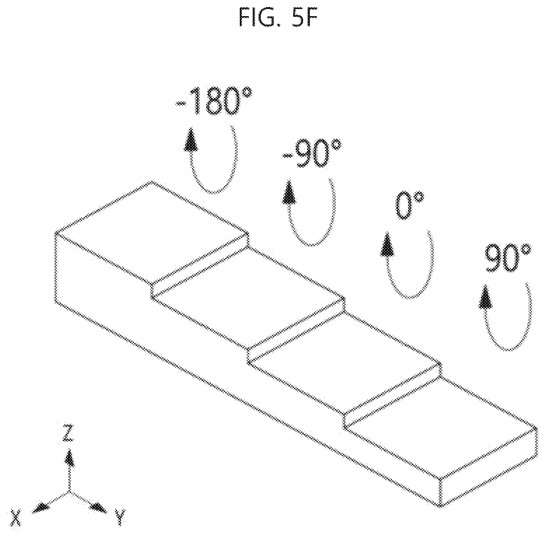

FIGS. 5A to 5G are drawings illustrating examples of states any one unit cell is able to have when coded with 2 bits. A super cell 110 including a unit cell 100 may be coded with a 2-bit value. In the illustrated embodiment, 2 bits may be a binary number of 00, 01, 10, or 11. The value for coding the unit cell 100 may correspond to a phase difference between an incident wave incident to the unit cell 100 and a scattered wave scattered and formed by the unit cell 100.

As an example, the phase difference between the incident radio wave and the scattered radio wave may be 0° when the unit cells 100 included in the super cell 110 are coded with “00”, the phase difference between the incident radio wave and the scattered radio wave may be 90° when the unit cells 100 are coded with “01”, the phase difference between the incident radio wave and the scattered radio wave may be 180° when the unit cells 100 are coded with “10”, and the phase difference between the incident radio wave and the scattered radio wave may be 270° when the unit cells 100 are coded with “11”.

Thus, when the unit cell 100 is coded with 2 bits as exemplified, the phase difference between the incident radio wave and the scattered radio wave may be formed as a resolution of 90° (=360°/2²). As an example not illustrated, when the unit cell is coded with 4 bits, the phase difference between the incident radio wave and the scattered radio wave may be formed as a resolution of 22.5° (=360°/2⁴). As the phase difference between the incident wave and the scattered wave is formed, the super cell including the unit cell may steer the incident wave at a targeting angle.

The value for coding the unit cell 100 included in the super cell 110 may be assigned to the unit cell 100 included in the super cell 110 as the scattering surface design process of the present embodiment ends. The unit cells 100 may be formed according to the assigned value.

Referring to FIGS. 5A to 5C, scattering cells may have a size capable of scattering a radio wave at a predetermined phase difference. Unit cells may be formed in quadrangular shapes with different sizes as exemplified in FIG. 5A, unit cells may be formed in “+” shapes with different sizes as exemplified in FIG. 5B, or unit cells may be formed in ring shapes with different sizes as exemplified in FIG. 5C.

Referring to FIG. 5D, scattering cells may be rotated and located at angles capable of scattering a radio wave at predetermined phase differences. As exemplified in FIG. 5D, as the “+” pattern of the same size is rotated and disposed at a predetermined angle on the surface of a substrate, the unit scattering cell may scatter an incident radio wave.

Referring to FIG. 5E, unit scattering cells may be formed at depths capable of scattering a radio wave at predetermined phase differences. As exemplified in FIG. 5F, unit scattering cells may be formed at heights capable of differently setting heights and scattering a radio wave at predetermined phase differences.

Referring to FIG. 5G, as a dielectric constant of the unit cell 100 varies or a permeability characteristic of the unit cell 100 is differently set, a radio wave speed may be adjusted to locally set a phase difference between a radio wave incident to the unit cell 100 and a radio wave scattered from the unit cell 100.

In the illustrated embodiment, unit cells may reflect an incident wave incident to the unit cells to form a scattered wave. A ground may be located on a lower portion of the substrate sub on which the unit cell is formed. Other than the embodiments of FIGS. 5A to 5G, various structures capable of specifying a local reflection phase in the design of the scattering surface may be applied to reflective scattering surface design.

In another embodiment not illustrated, a unit cell may transmit an incident wave to form a scattered wave. In such an embodiment, the unit cell may be any one of a metasurface of a multilayer scatterer structure, a frequency selective surface (FSS), a waveguide, both of which are open as a phase delay is applied, or a dielectric structure which does not include the ground. The unit cell may set a local transmission phase difference between an incident radio wave and a transmitted radio wave and may constitute a super cell using it to steer a beam in a targeting direction.

As an embodiment, the unit cell may form a scattering surface by applying a unit cell capable of controlling a phase to a transverse electric (TE) wave which is a first polarized wave or a transverse magnetic (TM) wave which is a second polarized wave depending on a polarized wave of the incident wave. This is able to be implemented by varying a first size in the direction of the first polarized wave or differently setting a second size in the direction of the second polarized wave. As an embodiment applying it, like the structures of FIG. 5A to 5C, a square structure which has the same size in the first direction and the second direction may be selected to implement a unit cell which operates for both of a dual-polarized wave in which first polarized wave and second polarized wave are mixed and a circular polarized wave. Furthermore, like the structures of FIGS. 5E to 5G, a unit cell of the dual-polarized wave and the circular polarized wave may be implemented using a structure and material having the same operation characteristic regardless of a type of the polarized wave.

Thus, the unit cell may be applied to design a scattering surface having a flat-top pattern for the first polarized wave and the second polarized wave. Furthermore, in another embodiment not illustrated, the size in the direction of the first polarized wave and the size in the direction of the second polarized wave may be changed independently of each other to independently adjust a phase of the first polarized wave and a phase of the second polarized wave. Thus, the unit cell may be applied to design a scattering surface having different scattering patterns for the first polarized wave and the second polarized wave.

As will be described below, the unit cells exemplified in FIGS. 5A to 5G are formed to scatter a radio wave incident at a predetermined phase difference depending on the assigned value. Furthermore, the plurality of unit cells included in the scattering surface may be grouped into respective groups. The unit cells included in the same group are assigned phase values which gradually increase or decrease to have a phase gradient corresponding to a beam steering angle and scatter an incident wave.

Hereinafter, a description will be given of an example in which the scattering surface includes 24×24 unit cells and the unit cells form one super cell with four in any one direction. In an example, because the scattering surface includes an even number of super cells in any one direction, half of the super cells may form a beam steered in a first direction and the rest of the super cells may form a beam steered in a second direction which is a direction opposite to the first direction. However, this is for easy understanding and description, which does not exclude a case in which the scattering surface includes an odd number of super cells in any one direction.

When the scattering surface includes an odd number of super cells, the intermediate super cell may form a beam steered in a normal direction of the scattering surface and the rest of super cells may form a beam steered in the first direction and a beam steered in the second direction which is the direction opposite to the first direction by half.

As described above, the scattering surface may be designed by being divided into the super cells including the plurality of unit cells to reduce the number of cases to reduce an optimization algorithm performance time while maintaining the diversity of the design.

In the step (S100) of setting the plurality of scattering surfaces, beam steering angles of the super cells included in the set scattering surfaces may be specified as random values and a scattering surface having multiple beams in which the random steering angles of the super cells overlap with each other to be synthesized into one from it.

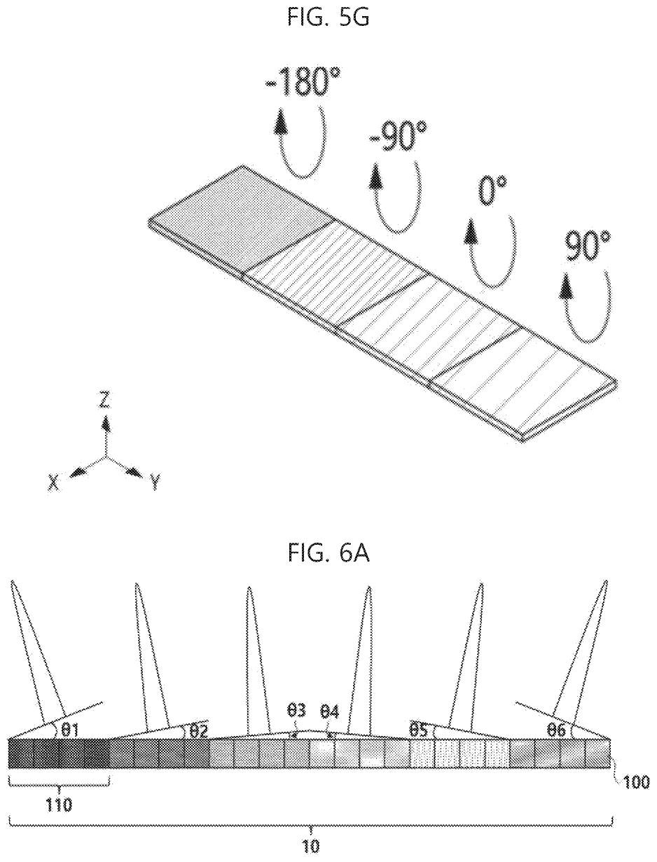

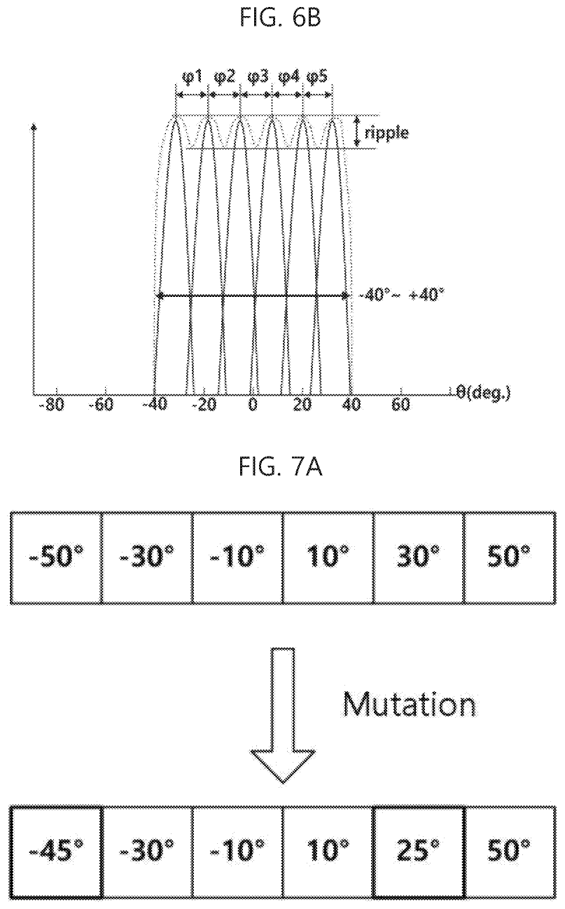

FIG. 6A is a drawing illustrating beams to be obtained using a scattering surface 10 of the present embodiment. FIG. 6B is a drawing schematically illustrating a scattered wave formed with respective beams. In an example exemplified in FIG. 6A, super cells 110 included in the scattering surface 10 may scatter an incident wave depending on a coded value to form a beam. It may be seen that the super cells 110 scatter an incident wave at steering angles θ1, θ2, . . . , and θ6 to form a beam, respectively.

Referring to FIG. 6B, it may be seen that beams formed by the respective super cells have ripples in main lobes at predetermined angles of −40° to 40°. Furthermore, beams formed as the respective super cells scatter the incident wave may have relative phase differences of (φ1=0°, φ2, . . . , and φ5), respectively. As will be described below, when the steering angles (θ1, θ2, . . . , and θ6) and the phase differences (φ=0°, φ2, . . . , and φ5) are input to a genetic algorithm as a design parameter to optimize the genetic algorithm, beams scattered from the unit cell may be offset to interfere with each other to prevent a null point from being formed. Herein, a phase of a scattered beam formed by the first super cell may be set to 0° and a phase difference may be applied to the rest of beams.

A cost function may be computed and evaluated for the set scattering surfaces (S200). A scattered wave formed by the scattering surface including the plurality of super cells may be composed of the beam formed by each of the super cells. Thus, the scattered wave formed by the scattering surface may be displayed with Equation 1 below.

$${E}^{s} = {\sum }_{p = 1}^{P} {E}^{p - th beam} {e}^{j {φ}_{p}} \qquad [ Equation 1 ]$$

$$Where {E}^{p - th beam} = {\sum }_{n = ( p - 1 ) Q + 1}^{p Q} {E}_{n}^{i} {Γ}_{n}^{pol .} {cos}^{{q}_{e}} θ {e}^{j \{ ( - \frac{N + 1}{2} + n ) {k}_{0} d sin θ \}} , {E}_{n}^{i} = {E}_{0}^{i} {e}^{- j ( - \frac{N + 1}{2} + n ) {k}_{0} d sin {θ}_{i}} , and$$

$${Γ}_{n}^{pol .} = {e}^{- j ( - \frac{N + 1}{2} + n ) {k}_{0} d [ sin {θ}_{p} - sin {θ}_{i} ]}$$

(E^{S}: the electric field distribution of the scattering pattern, θₚ: the beam steering angle by the pth super cell, φₚ: the phase angle of the beam formed by the pth super cell,

$${E}_{n}^{i} :$$

the electric field distribution of the incident wave, P: the number of beams by the super cell, Q: the number of unit cells included in the super cell, cosθ is the radiation pattern of the unit cell, and Γₙ: the scattering coefficient of the unit cell).

The cost function may be displayed as Equation 2 below from the equation of the above-mentioned scattered wave.

$$cost function = {max}_{θ ∈ {θ}_{s}} ( {\vert {E}^{s} ( θ ) \vert}_{dB} ) - {min}_{θ ∈ {θ}_{s}} ( {\vert {E}^{s} ( θ ) \vert}_{dB} ) \qquad [ Equation 2 ]$$

In other words, the cost function refers to a difference between a maximum value of the scattered wave and a minimum value of the scattered wave in a steering angle range of the scattered wave. When the cost function value is large, a large ripple is formed in a main lobe steering angle range of the scattered wave. This indicates that the amplitude of the scattered wave formed by the scattering surface is not uniform.

On the other hand, when the cost function value is small, a small ripple is formed in the main lobe steering angle range. This indicates that the amplitude of the scattered wave formed by the scattering surface is uniform.

As an embodiment, a cost function is computed for the set scattering surface and a plurality of scattering surfaces having the smallest cost function value are selected. As an embodiment, the selected scattering surfaces may be selected at any one of 10% to 50% of the number of scattering surfaces, which is initially set.

The design parameter of the super cell included in the scattering surfaces selected according to the cost function value is changed using the genetic algorithm (S300). As an embodiment, the parameter of the super cell may be beam steering angles (θ1, θ2, . . . , and θ6) and phase differences (φ1=0°, φ2, . . . , and φ6) of the scattered beam. As an example, to prevent a null point from occurring due to interference between beams which overlap with each other to have a flat pass characteristic in the main lobe, a phase of a scattered beam formed by any one super cell is set to 0° to apply relative phase differences {φ1=0°, φ2, φ3, . . . , φ6} to the rest of beams.

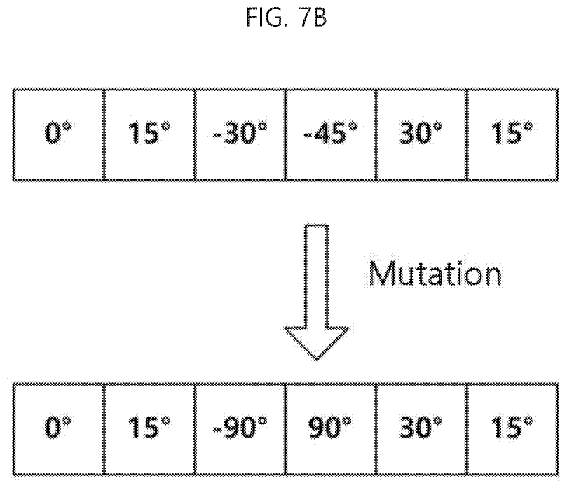

As an embodiment, the step of changing the parameter of the super cell using the genetic algorithm may be performed using any one or more of mutation and cross-over. FIG. 7A is a drawing illustrating mutation for a beam steering angle sequence of selected scattering surfaces. FIG. 7B is a drawing illustrating mutation for a phase angle sequence of selected scattering surfaces. Referring to FIG. 7A, the mutation may be performed as a value of any one element included in the sequence randomly changes. A position where the mutation occurs in the sequence and a value which changes depending on the mutation may be random values. Referring to FIG. 7B, the mutation may occur even in one or more consecutive elements in the sequence. As an embodiment, a probability that mutation will occur and a probability of the position where the mutation occurs and the changed value may be defined by a user.

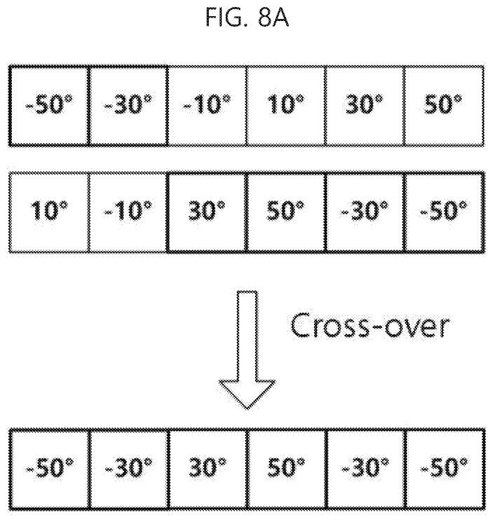

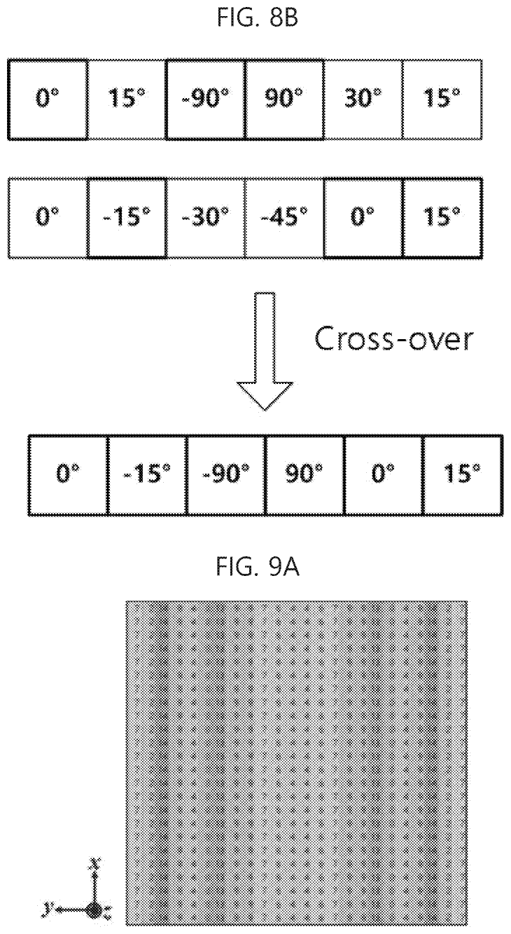

FIG. 8A is a drawing illustrating cross-over for a beam steering angle sequence of selected scattering surfaces and a beam steering angle sequence of scattering surfaces. FIG. 8B is a drawing illustrating cross-over for a phase angle sequence of any one selected scattering surface and a phase angle sequence of another scattering surface. Referring to FIG. 8A, the cross-over may be performed by exchanging some elements included in any sequence and some elements included in another sequence. The crossed-over element may be a single element or a plurality of elements.

Referring to FIG. 8B, the cross-over may occur even in the plurality of elements in the sequence. A position where he cross-over occurs in the sequence may be a random value. As an embodiment, a probability that the cross-over will occur and a probability of the position where the cross-over occurs and the changed value may be defined by the user.

In an embodiment, after any one of the mutation and the cross-over may be performed, the other may be subsequently performed. Which of the mutation and the cross-over is first selected may be randomly determined. In another embodiment, only any one of the mutation and the cross-over may be selectively performed and the mutation and the cross-over may be randomly determined and performed.

A beam steering angle sequence and a phase angle sequence newly generated by a genetic algorithm may form a new scattering surface. Herein, when the beam steering angle sequence and the phase angle sequence are determined, unit cells included in each super cell may have a coding value of a phase which gradually increases or decreases.

A cost function may be computed from the parameter changed according to the genetic algorithm to evaluate a scattering characteristic (S400). Equation 1 above may be computed using the parameter of the newly generated scattering surface and the cost function may be computed from it. As an embodiment, it is identified whether the computed cost function value meets an end condition. If it is not met, it may perform the step again from the step (S300) of changing the parameter using the genetic algorithm.

As an embodiment, the cost function value computed using the parameter of the newly generated scattering surface and cost function values of an existing scattering surface may be compared to remove any one of 10%, 15%, and 20% of a scattering surface having the lowest cost function. As such, the scattering surface having the lowest cost function may be removed, the cost function values of the remaining scattering surfaces may overall increase.

As an embodiment, the end condition may be a case in which the cost function value exemplified in Equation 2 above is less than or equal to a specified value. As described above, the case in which the cost function value is less than or equal to the specified value may be a case of scattering an incident wave in a targeting predetermined wide range and having a flat-top characteristic as a ripple in the main lobe of the scattered wave is low.

### Implementation Example

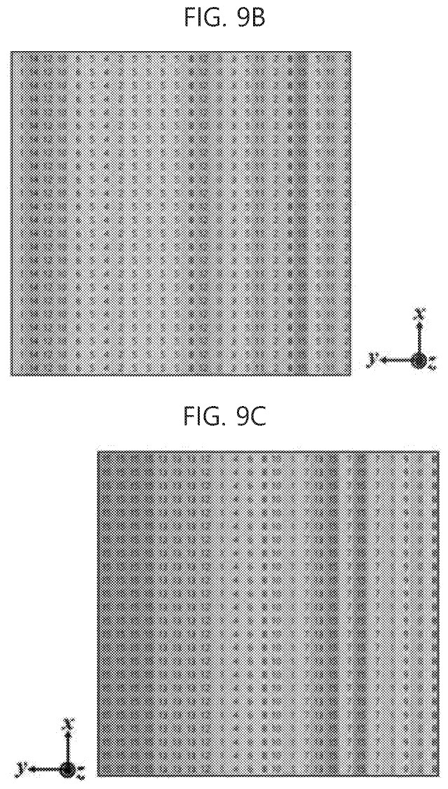

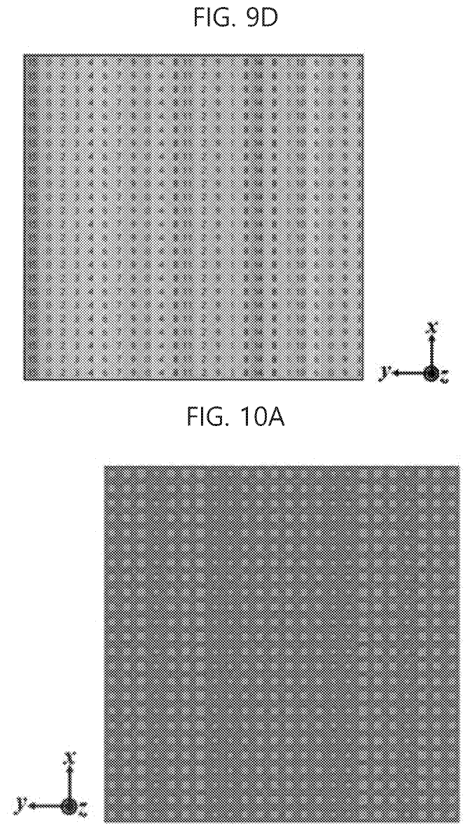

FIGS. 9A, 9B, 9C, and 9D are drawings illustrating multi-bit coding phase distribution of a scattering surface designed under a condition, including 24×24 unit cells (size: 12 wavelengths×12 wavelengths), of 4-bit phase coding and a scattering range of [−40°, 40°]. FIG. 9A, FIG. 9B, FIG. 9C, and FIG. 9D are scattering surfaces designed for incident plane waves, incident angles of which are 0°, 15°, 30°, and 45°, respectively. The scattering surfaces are designed such that a null does not occur in the range of [−40°, 40°], which is a design condition, for a scattering pattern on the yz plane.

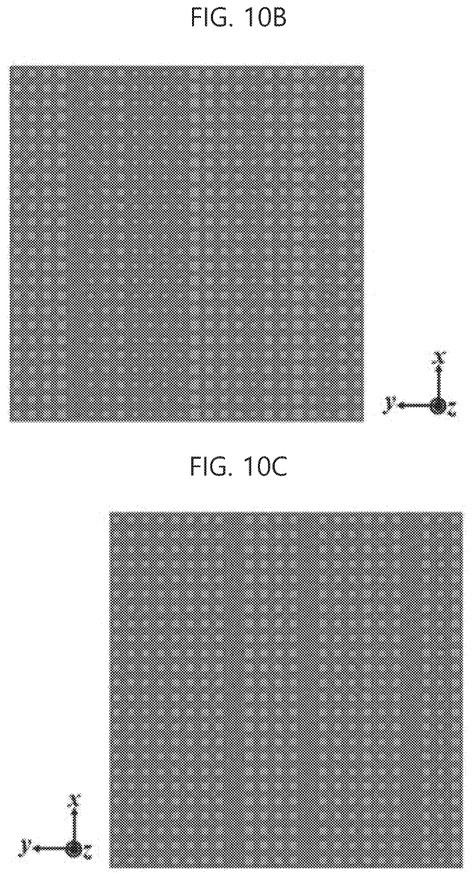

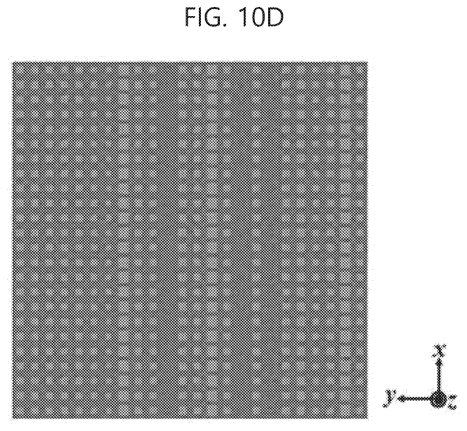

FIGS. 10A, 10B, 10C, and 10D illustrate a reflective scattering surface structure in which an embodiment exemplified in FIGS. 9A, 9B, 9C, and 9D is implemented with a PCB. FIGS. 10A, 10B, 10C, and 10D correspond to structures in which FIGS. 9A, 9B, 9C, and 9D are actually implemented, respectively. The exemplified implementation example is an example of reflecting and scattering an incident wave, which has a structure in which the grounds are arranged on a lower portion with respect to a dielectric substrate and square patches are arranged on an upper portion with respect to the dielectric substrate.

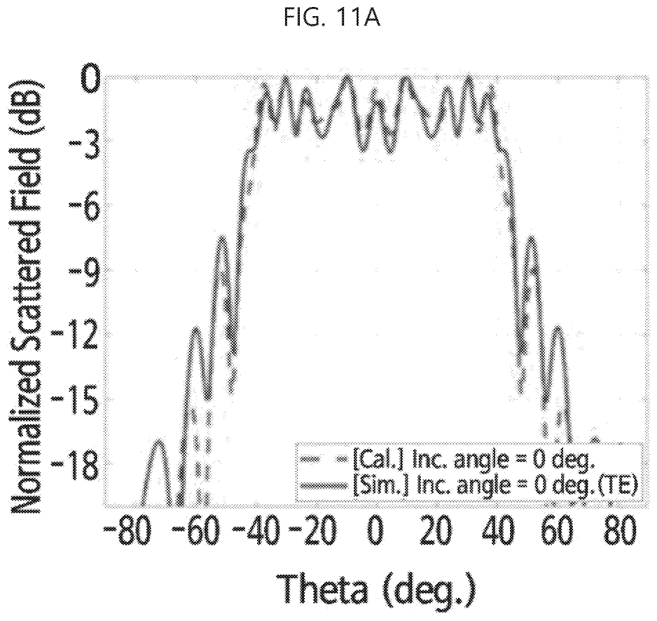

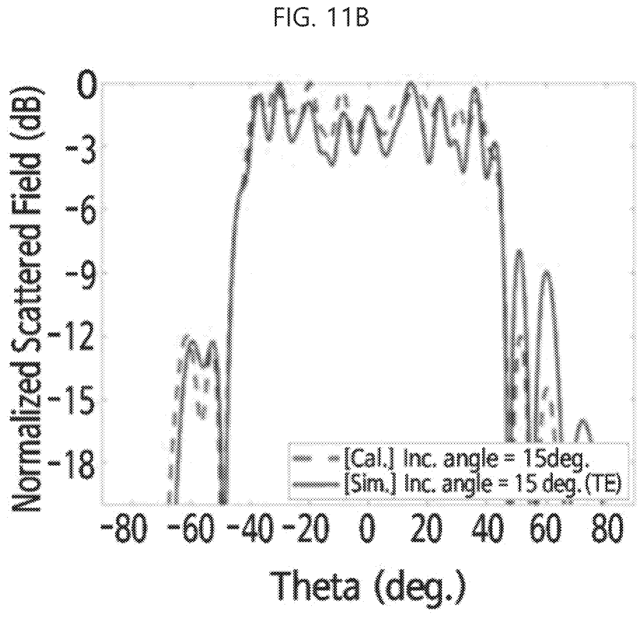

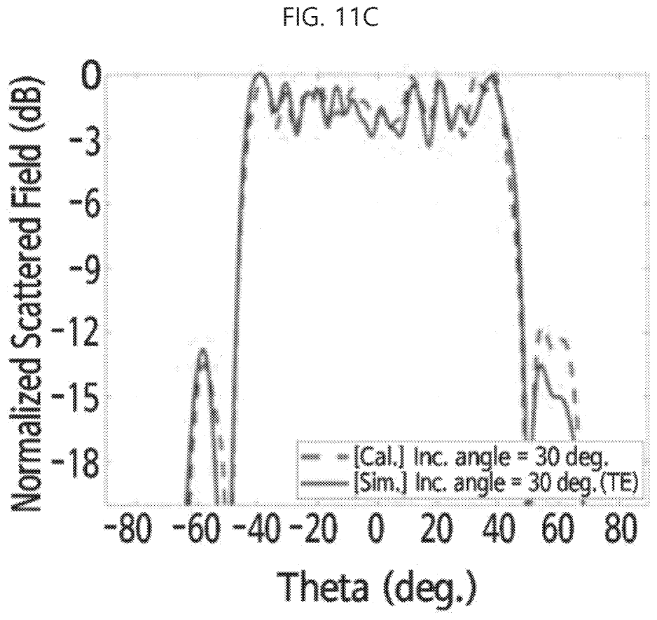

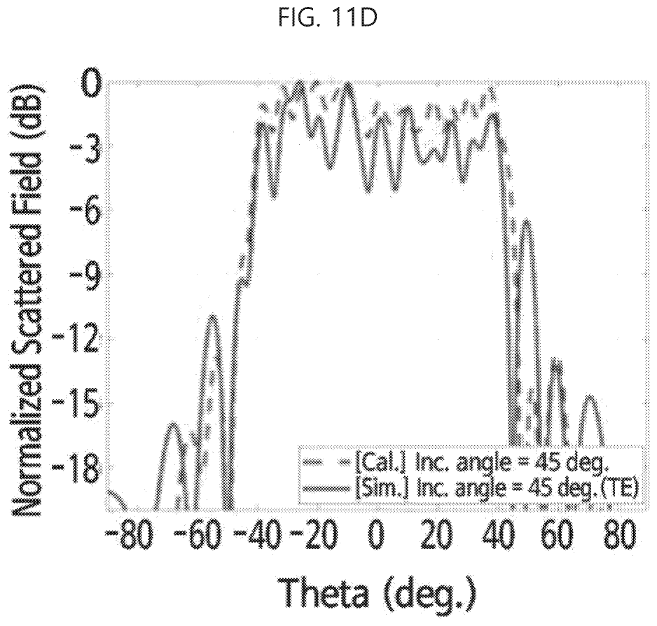

FIGS. 11A, 11B, 11C, and 11D are drawings illustrating the result of simulating a scattering pattern of a TE wave which is a first polarized wave on the yz plane for reflective scattering surfaces of FIGS. 10A, 10B, 10C, and 10D. Red dotted lines are a result optimized via the model and algorithm and blue dotted lines are the result of simulating a radio wave for a metasurface structure of a PCB. Assuming that an incident plane wave is incident at 0°, 15°, 30°, and 45° on the yz plane, it may be checked that a flat-top scattering pattern is formed without nulls on the yz plane.

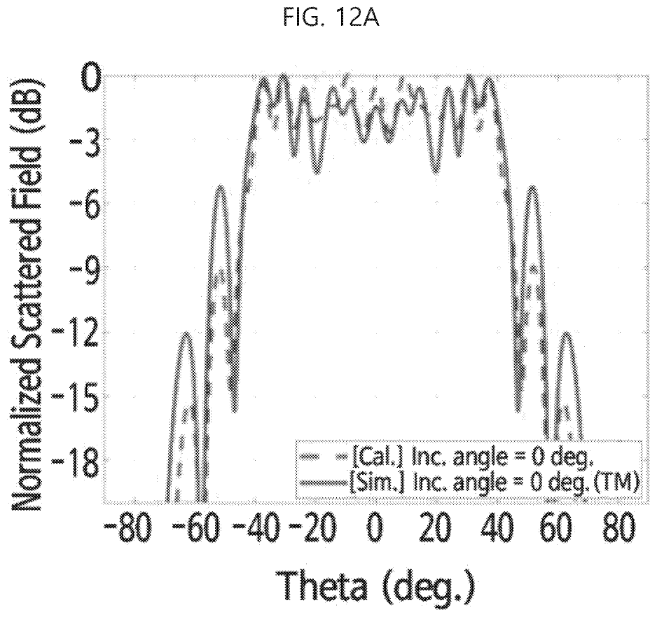

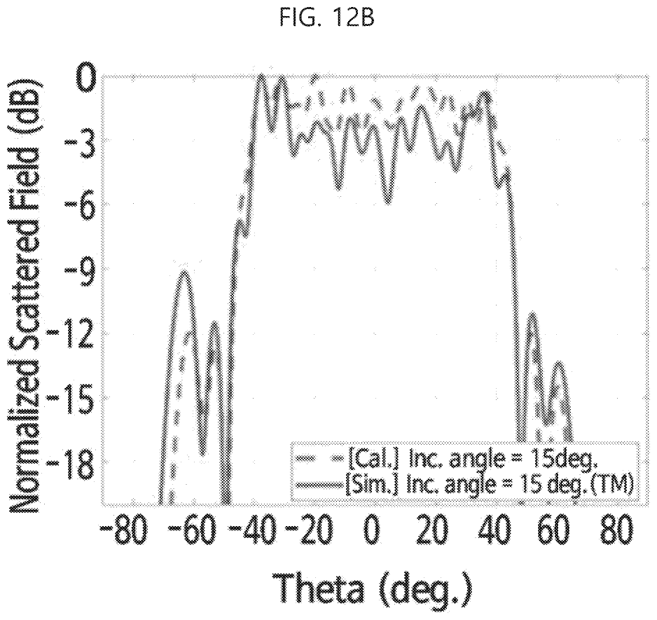

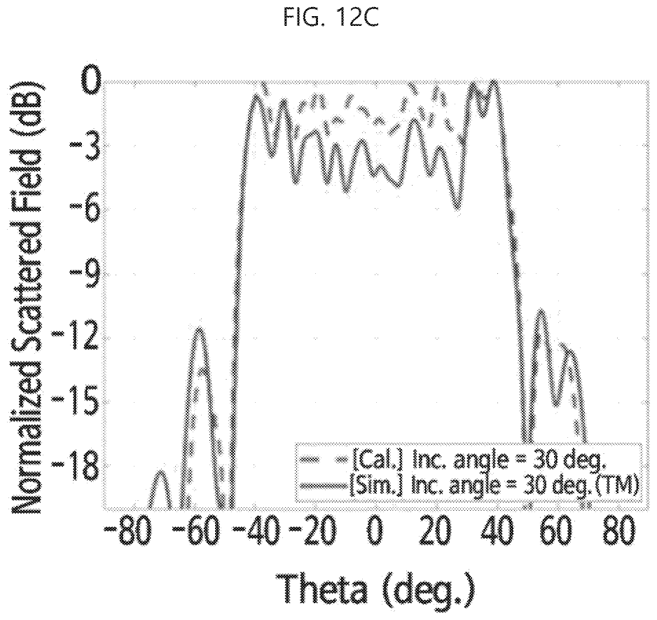

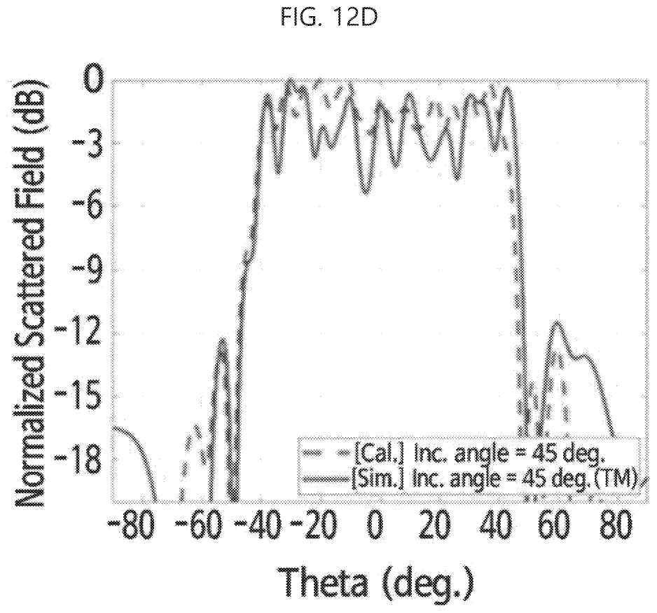

Herein, the degree of the null is set to −6 dB compared to a peak of the scattered wave. Furthermore, FIGS. 12A, 12B, 12C, and 12D illustrate a scattering characteristic of a TM wave which is a second polarized wave. A first null beamwidth (FNBW) in which the degree of flat-top indicates an angle between first null and another null is greater than or equal to 90° in the results of FIGS. 11A to 11D and FIGS. 12A to 12D.

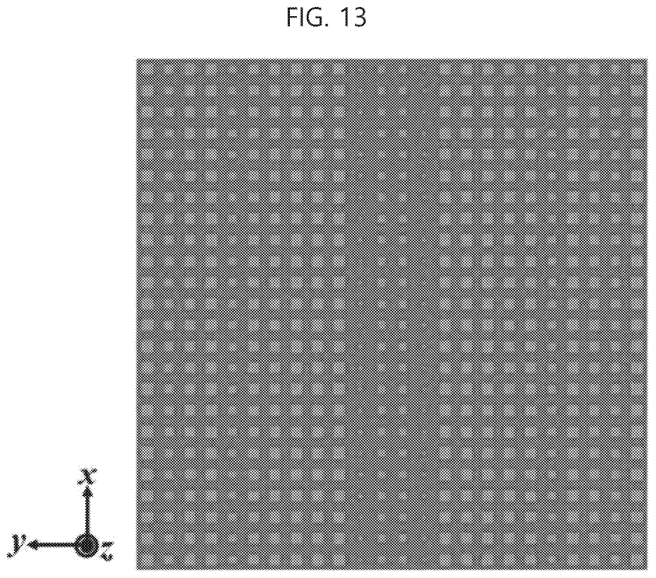

FIG. 13 is a drawing illustrating a structure in which a design result under a condition of 24×24 elements (size: 12 wavelengths×12 wavelengths), 4-bit phase coding, and a scattering surface of [−40°, 40°], as an embodiment of a transmissive scattering surface, is implemented with a PCB. The transmissive scattering surface of the embodiment is designed in a multi-layer structure in which a 5-layer metal pattern with the same size is printed on a 4-layer substrate to ensure transmission phase coverage.

As described above, the transmissive scattering surface may be designed in various structures other than a square patch multi-layer structure. Furthermore, the design may be implemented to laminate and form the substrate and the metal pattern used in the embodiment and metal patterns in various shapes other than the square patches may be applied to the design.

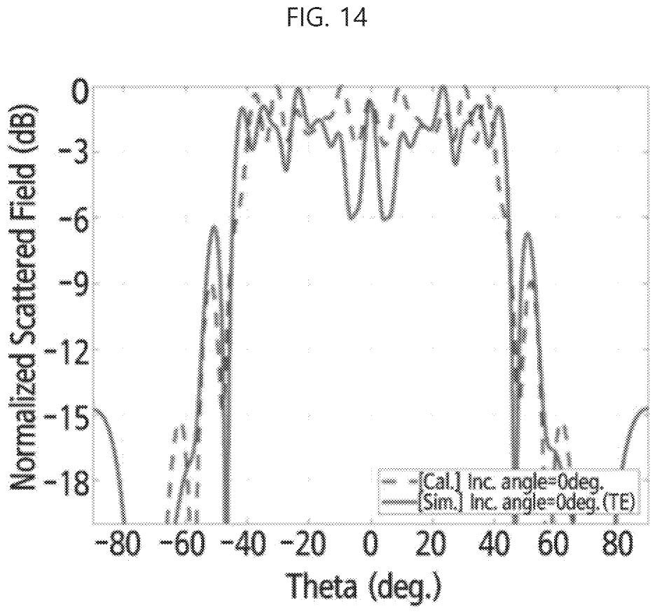

FIG. 14 illustrates the result of simulating a scattering pattern of a TE wave which is a first polarized wave on the yz plane for a transmissive scattering surface of FIG. 13. It is checked that an FNBW is greater than or equal to 90°. Although not illustrated, because the transmissive scattering surface is in the form of a square unit cell to be the same as the reflective scattering surface, it may operate even for a TM wave which is a second polarized wave and may also operate even for a dual-polarized wave in which the first polarized wave and the second polarized wave are mixed and a circular polarized wave.

According to the present embodiment, the scattering surface capable of scattering the incident wave in the set range to form the scattered wave having the flat-top characteristic may be formed.

In addition to the basic patch presented in the above embodiment, various unit cell structures may be applied to add or enhance specific functions.

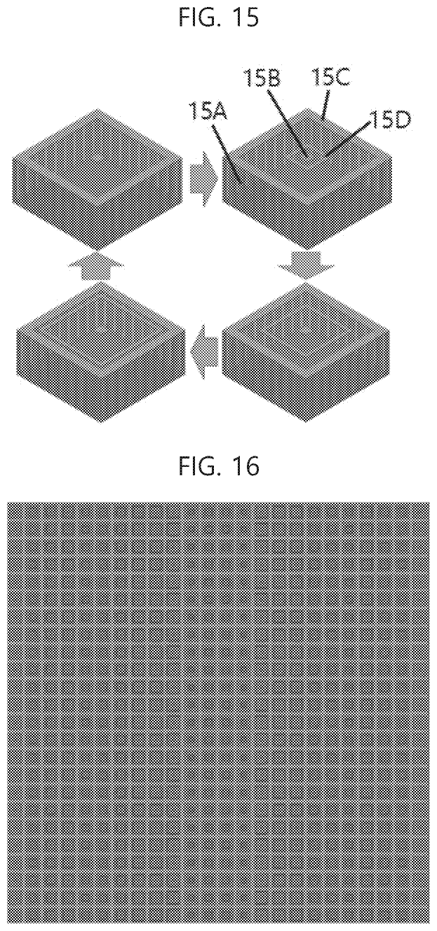

FIG. 15 is a diagram illustrating the structure and phase change principle of a Cavity Phoenix Cell, which is another structure of the present embodiment for reducing mutual coupling between adjacent cells while obtaining broadband characteristics. The cavity structure is implemented through via walls 15A to effectively block surface waves, and the broadband characteristics are implemented through a Phoenix Cell that changes the reflection phase through an intermediate ring 15D that changes in size between a central patch 15B and an outer ring 15C. The Phoenix Cell is a structure in which the intermediate ring 15D gradually increases from the central patch 15B to reach the outer ring 15C and returns to its initial state. The cavity phoenix cell is symmetric with respect to the first direction in the x-axis direction and the second direction in the y-axis direction, so it is a dual-polarization structure capable of operating for both the first polarization, the TE wave, and the second polarization, the TM wave.

FIG. 16 shows a reflective scattering surface implemented with the cavity phoenix cell of FIG. 15. The scattering surface of FIG. 16 is a structure implemented on a PCB as a reflective scattering surface based on the result of FIG. 9, which has a 24×24 element (size: 12 wavelengths×12 wavelengths), 4-bit phase coding, and a scattering range condition of [−40 degrees, 40 degrees].

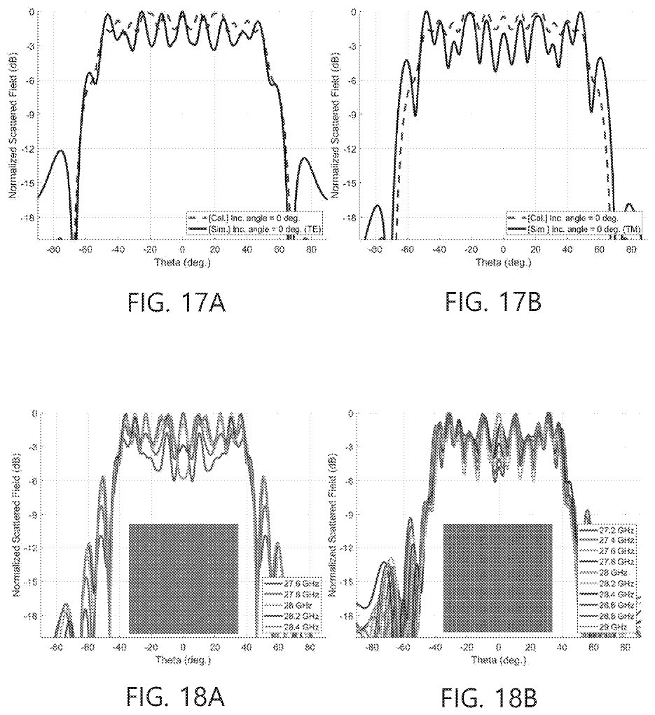

FIG. 17A and FIG. 17B are diagrams showing the scattering pattern on the yz plane for the reflective scattering surface of FIG. 16, where FIG. 17A shows the result for the first polarization (TE wave) and FIG. 17B shows the result for the second polarization (TM wave). Similar to the previous results, it can be confirmed that a flat-top scattering pattern is formed on the yz plane without any nulls.

FIG. 18A and FIG. 18B are diagrams comparing the frequency-dependent scattering patterns of a reflective scattering surface designed with a general patch unit cell (FIG. 18A) and a cavity phoenix cell according to an embodiment of the present invention (FIG. 18B). Based on a ripple of 6 dB, the scattering surface designed with a general patch maintained constant performance in the 27.6-28.4 GHz range (0.8 GHz bandwidth), whereas the scattering surface designed with a cavity phoenix cell maintained constant performance in the 27.2-29 GHz range (1.8 GHz bandwidth). When expressed as fractional bandwidth, these are calculated as 2.9% and 6.4%, respectively, confirming an effect where the bandwidth has increased by approximately 2.25 times.

The description is given with reference to the embodiments illustrated in the drawings to help understand the present invention, but this is only an embodiment for implementation, and it will be understood that various modifications and other equivalent embodiments are possible from this point by those skilled in the art. Thus, the technical protection scope of the present disclosure will be defined by the technical spirit of the appended claims.

What is claimed is:

1. A scattering surface design method for designing a scattering surface on which super cells, each of which includes a plurality of unit cells, are regularly arranged, the scattering surface design method comprising:
a step of setting a plurality of scattering surfaces defined with a parameter corresponding to beams formed by the super cells;
a cost function evaluation step for the scattering surfaces;
a genetic change step of changing the parameter using a genetic algorithm;
a scattering characteristic evaluation step of computing a cost function from the parameter changed according to the genetic algorithm to evaluate a scattering characteristic; and
a step of performing the genetic change step and the scattering characteristic evaluation step until an end condition for a targeting scattering characteristic is met.

2. The scattering surface design method of claim 1, wherein the parameter includes steering angles of the beam formed by the super cell and phase differences between the beams formed by the super cells.

3. The scattering surface design method of claim 2, wherein the steering angle of the beam corresponds to a value for encoding a plurality of super cells.

4. The scattering surface design method of claim 1, wherein the set scattering surfaces are defined with different parameters, respectively and are set by a predetermined number, in the step of setting the scattering surfaces.

5. The scattering surface design method of claim 1, wherein the cost function evaluation step is performed by computing a ripple in a main lobe of a radio wave scattered from the scattering surface defined with the parameter.

6. The scattering surface design method of claim 5, wherein the cost function evaluation step is performed by assigning smaller cost as the ripple in a main lobe of a beam scattered and formed by super cells included in the scattering surface is smaller in size and is performed by selecting scattering surfaces of 10% to 50% having smallest cost among the plurality of set scattering surfaces.

7. The scattering surface design method of claim 1, wherein the genetic change step is performed by including:
a step of performing mutation for changing any one or more of parameters corresponding to a beam defining the scattering surface in which a cost function is evaluated; and
a step of forming a scattering surface corresponding to new parameters formed as the mutation is performed.

8. The scattering surface design method of claim 1, wherein the genetic change step is performed by including:
a step of performing cross-over for crossing over a portion of a sequence of parameters corresponding to a beam defining the scattering surface in which a cost function is evaluated; and
a step of forming a scattering surface including the super cells corresponding to a new parameter generated as the cross-over is performed.

9. The scattering surface design method of claim 1, wherein the cost function is displayed with an equation cost function=max_{θ∈θ}_{_{S}}(|E^{S}(θ)|_{dB)}−min_{θ∈θ}_{_{S}}(|E^{S}(θ)|_{dB})(E^{S}: an electromagnetic wave in a main lobe in a scattered wave and θ_{S}: a targeting optimization steering angle).

10. The scattering surface design method of claim 1, wherein the scattering surface reflects or transmits an incident wave to form a scattered wave,
wherein the scattering surface for reflecting the incident wave further includes a ground, and
wherein the scattering surface for transmitting the incident wave is formed as one or more scattering surfaces are laminated.

11. A scattering surface design apparatus for designing a scattering surface including unit scattering cells arranged on a substrate, the scattering surface design apparatus comprising:
a memory storing a design method program for designing a scattering surface; and
a processor configured to perform the design method program for designing the scattering surface,
wherein the processor is configured to design a scattering surface on which super cells, each of which includes a plurality of unit cells, are regularly arranged, and
wherein the processor is configured to perform:
a step of setting a plurality of scattering surfaces defined with a parameter corresponding to beams formed by the super cells;
a cost function evaluation step for the scattering surfaces;
a genetic change step of changing the parameter using a genetic algorithm;
a scattering characteristic evaluation step of computing a cost function from the parameter changed according to the genetic algorithm to evaluate a scattering characteristic; and
a step of performing the genetic change step and the scattering characteristic evaluation step until an end condition for a targeting scattering characteristic is met.

12. The scattering surface design apparatus of claim 11, wherein the parameter includes steering angles of the beam formed by the super cell and phase differences between the beams formed by the super cells.

13. The scattering surface design apparatus of claim 12, wherein the steering angle of the beam corresponds to a value for encoding a plurality of super cells.

14. The scattering surface design apparatus of claim 11, wherein the set scattering surfaces are defined with different parameters, respectively and are set by a predetermined number, in the step of setting the scattering surfaces.

15. The scattering surface design apparatus of claim 11, wherein the cost function evaluation step is performed by computing a ripple in a main lobe of a radio wave scattered from the scattering surface defined with the parameter.

16. The scattering surface design apparatus of claim 15, wherein the cost function evaluation step is performed by assigning smaller cost as the ripple in a main lobe of a beam scattered and formed by super cells included in the scattering surface is smaller in size and is performed by selecting scattering surfaces of 10% to 50% having smallest cost among the plurality of set scattering surfaces.

17. The scattering surface design apparatus of claim 11, wherein the genetic change step is performed by including:
a step of performing mutation for changing any one or more of parameters corresponding to a beam defining the scattering surface in which a cost function is evaluated; and
a step of forming a scattering surface corresponding to new parameters formed as the mutation is performed.

18. The scattering surface design apparatus of claim 11, wherein the genetic change step is performed by including:
a step of performing cross-over for crossing over a portion of a sequence of parameters corresponding to a beam defining the scattering surface in which a cost function is evaluated; and
a step of forming a scattering surface including the super cells corresponding to a new parameter generated as the cross-over is performed.

19. The scattering surface design apparatus of claim 11, wherein the cost function is displayed with an equation cost function=max_{θ∈θ}_{_{S}}(|E^{S}(θ)|_{dB})−min_{θ∈θ}_{_{S}}(|E^{S}(θ)|_{dB})(E^{S}: an electromagnetic wave in a main lobe in a scattered wave and θ_{S}: a targeting optimization steering angle).

20. The scattering surface design apparatus of claim 11, wherein the scattering surface reflects or transmits an incident wave to form a scattered wave,
wherein the scattering surface for reflecting the incident wave further includes a ground, and
wherein the scattering surface for transmitting the incident wave is formed as one or more scattering surfaces are laminated.
